(19) United States
(12) Patent Application Publication
(10) Pub. No.: US 2026/0036881 A1
(43) Pub. Date: Feb. 5, 2026

(54) REFLECTOR DESIGN FOR RED GLOW MITIGATION

(71) Applicant: MAGNA ELECTRONICS, LLC, Southfield, MI (US)

(72) Inventors: Ilya FEDAROVICH, Southfield, MI (US); Samantha Renee HICKS, Southfield, MI (US)

(73) Assignee: MAGNA ELECTRONICS, LLC, Southfield, MI (US)

(21) Appl. No.: 18/788,431

(22) Filed: Jul. 30, 2024

(51) Int. Cl. G03B 15/06

(52) U.S. Cl. CPC G03B 15/06

(57) ABSTRACT

A camera assembly for mitigating red glow is provided. A camera assembly may be configured for attachment to a vehicle. The camera assembly may include an imaging sensor and a light assembly. The imaging sensor may be configured to detect objects within a field of view. The light assembly may be configured to illuminate the field of view. The light assembly may include a light source that comprises a infra-red or near infra-red light emitting diode. The light source may oriented to be hidden from the field of view. A reflective concentrator may be configured to direct light from the light source to the field of view.

### FIELD OF THE INVENTION

The present disclosure is related to a reflective concentrator for red glow mitigation.

### BACKGROUND

In current motor vehicle designs sophisticated systems are used to evaluate the presence of occupants within the vehicle, along with characteristics and positioning of the occupants. Moreover, higher degrees of information can be obtained by capturing images of a vehicle's driver's face and even eye gaze direction. In order for such imaging systems to operate it is often necessary to provide an illumination source for the vehicle interior. So as to not distract the driver and to provide a comfortable interior environment such illumination and detection is frequently done using light wavelengths considered to be not visible to the occupants. Non-visible light can be used to minimize the effects of illumination within a field of view of an imaging system. However, in some instances, the human eye may have certain regions that are still sensitive to what is typically considered to be non-visible light. Accordingly, an improved illumination design may be desirable.

One method of NIR or IR LED “red glow” mitigation is filtration. This mitigation can be achieved by bandpass filtering out the standard visible light (400-700 nm) at a high optical density while passing through the target LED wavelengths to which the system is sensitive. This process does not entirely remove the visibility of a “red glow” on axis as the NIR or IR LED transmission will still reach the human eye when viewed on axis.

Another strategy to reduce NIR or IR LED “red glow” is to increase the wavelength output of the LED. Longer wavelength IRs may be less visible to the human eye. For example, a 940 nm NIR LED may have less “red glow” than an 850 nm LED. Lastly, if the intensity of the NIR/IR LED is low or the pulse duration is increased the “red glow” may be less visible.

A camera system which monitors subjects utilizing non-visible illumination may use NIR or IR wavelength illumination so that the illumination is not readily visible to the human eye. This is applicable to many applications, such as security cameras and in an automotive ADAS (“advanced driver assistance systems”) which monitor the interior of a vehicle. Human vision can often be sensitive in the 400-700 nm wavelength range, thus being described as the visible light region on the electromagnetic spectrum. NIR and IR wavelengths ˜700 nm-1 mm then often may be considered invisible to the human eye. However, this is not always the case due to the high visual acuity of the fovea region of the retina in a human eye. The effect of NIR or IR wavelength illumination being visible to the human eye is called “red glow.”

The fovea, the 10° central region of the retina, is the most densely packed region of the retina of cone, color receptors. From this, it has more recently been proven that the human eye can in fact see “invisible” infrared light when viewed on axis to the retina under certain conditions of intensity vs. pulse time of the stimulus.

This phenomena of the visibility of near infrared or infrared wavelengths is referred to as “red glow.” This “red glow” can impact applications such as security cameras and interior monitoring cameras in automotive applications where NIR or IR LEDs are used to light the scene area. In both cases, it is not ideal that the viewer can see the glow of the LEDs while the camera system is on.

### BRIEF SUMMARY

A camera assembly for mitigating red glow is provided in accordance with this disclosure. An exemplary camera assembly can be configured for attachment to a vehicle. The camera assembly includes an imaging sensor and a light assembly. The imaging sensor is configured to detect objects within a field of view. The light assembly is configured to illuminate the field of view. The light assembly includes a light source that comprises an infra-red or a near infra-red light emitting diode. The light source can be oriented to be hidden from the field of view. A reflective concentrator is configured to direct light from the light source to the field of view.

The disclosed design mitigates the effect of “red glow” through redirection of the light in a way that eliminates the visibility of that light with the use of a reflective concentrator, such as a compound parabolic concentrator (CPC) reflector. The reflective concentrator redirects the NIR or IR light to no longer be on axis with eyes in the field of view. The design also disperses the NIR or IR light so that the human eye is no longer able to perceive the light as “red glow.”

### BRIEF DESCRIPTION OF THE DRAWINGS

FIG. 1 is a schematic illustration of a reflective concentrator for red glow mitigation.

FIG. 2A is a top view of a camera assembly.

FIG. 2B is a front view of the camera assembly from FIG. 2A.

FIG. 2C is a front view of a camera assembly with rotated reflective concentrator.

FIG. 3 is a schematic diagram for a driver monitor.

FIG. 4 is a schematic diagram of a vehicle with sensors for monitoring the driver and outside environmental attributes.

### DETAILED DESCRIPTION

In one implementation, the reflective concentrator is a compound parabolic concentrator (CPC). A CPC can be formed by a parabola with its focus at one edge of the entrance (small) aperture, rotated around an axis that is perpendicular to and through the center of the output aperture. A CPC reflector may be used to redirect the NIR or IR LED illumination to be off-axis light from the human eye, this will cause the light source to no longer be visible. The shape of the CPC reflector may be calculated based off of the accompanying LED characteristics.

Following is a representative Design Output (Example):

TABLE 1
Sample Calculation Inputs and Outputs

| I/O | Parameter | Description | Sample Input |
|---|---|---|---|
| Input | di | Diameter of the LED active surface (mm) | 3.51 |
| Output | ⊖ max | Max Field Angle (Deg) | 46.86 |
| Output | L | Resulting Length of the CPC (mm) | 3.90 |
| Input | do | Diameter of the front CPC aperture (mm) | 4.81 |
| Output | FOV | Resulting Light Cone (Deg) | 93.73 |

The orientation of the CPC reflector may also determine the dispersion area of the NIR or IR LED light source. By rotating the CPC reflector to be off axis from the input aperture, the light source may no longer be visible.

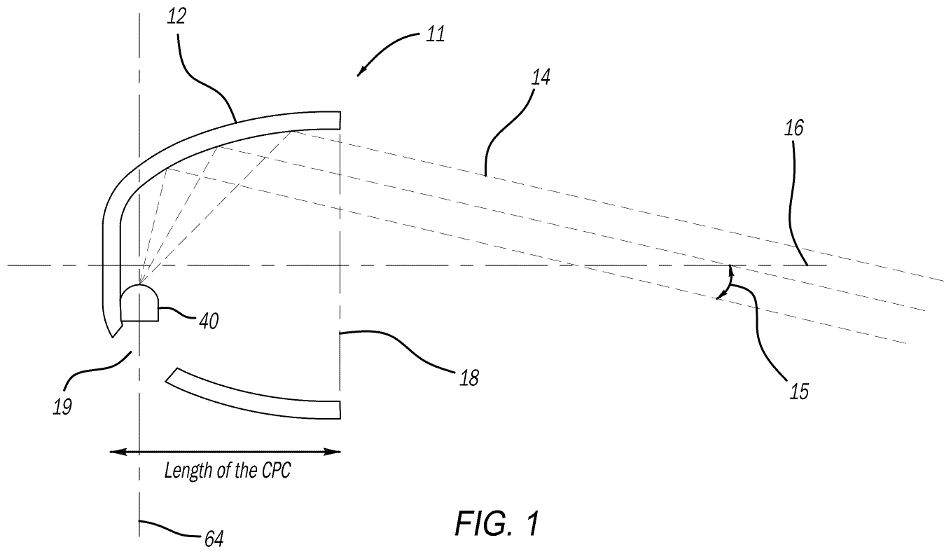

FIG. 1 is a schematic illustration of a light source assembly 11 for red glow mitigation which includes as principal components, concentrator 12 and light source 40. The concentrator 12 may be a reflective parabolic concentrator and may further be a reflective compound parabolic concentrator. The concentrator 12 defines a center axis 16. The center axis 16 extends through output aperture 18. Input aperture 19 is oriented displaced from center axis 16 along a line 64 perpendicular to the center axis. LED IR source 40 is mounted to present rays of light into input aperture 19. Reference number 14 illustrates the tracing of rays from an origin of the concentrator 12 which may be at one edge of the input aperture 19. For example, it may be at the opposite edge of the input aperture 19 from the concentrator 12. A maximum field angle θ 15 The invention discloses θ max as the angle between the reflected ray and the center axis 16. This angle is a result of various dimensions of the CPC and placement of the light source. Also discloses that the resulting light (FOI) angle is (2×θ max) of concentrator 12 is illustrated relative to the center axis 16. In some implementations, the maximum field angle may be greater than 10 degrees.

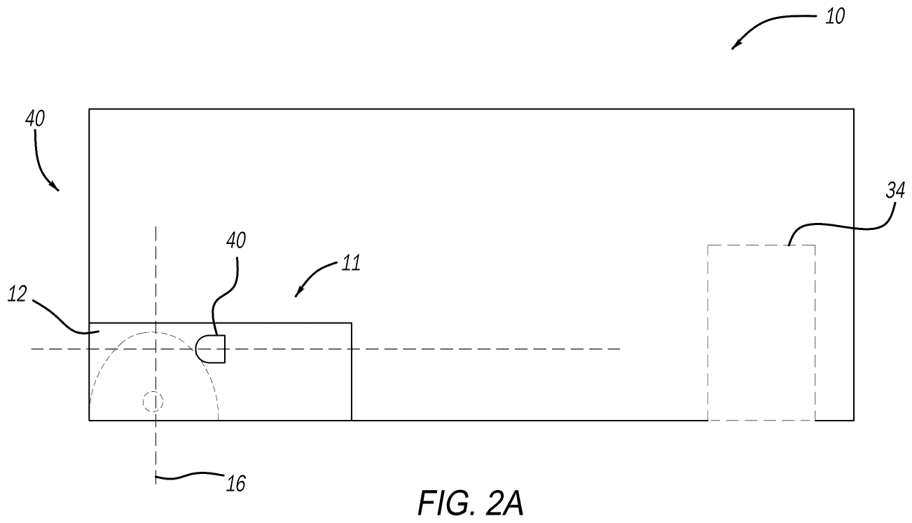

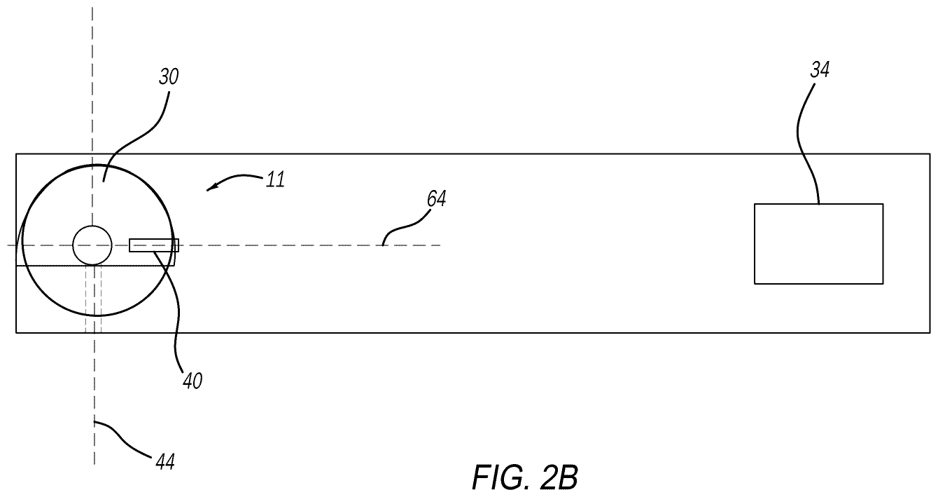

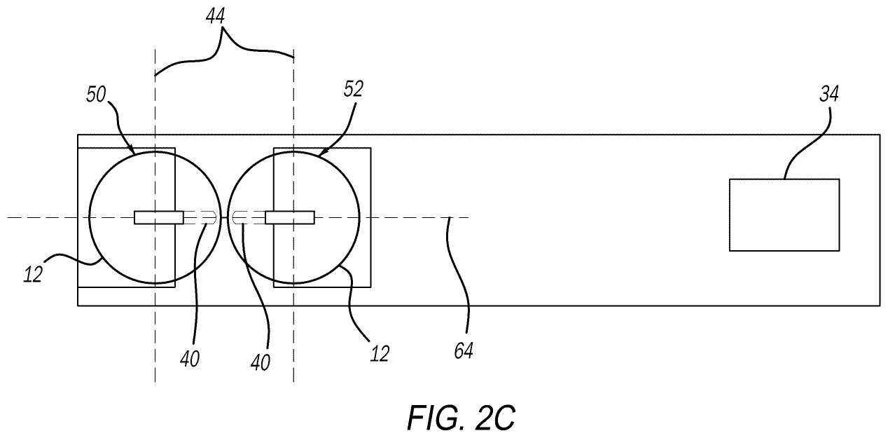

FIG. 2A is a top view of a camera assembly 10. The camera assembly 10 includes light source assembly 11 and an imaging sensor 34. The light source 40 is aligned with the concentrator 12 along line 64 as described above. Light source 40 may be an IR or NIR light source and may be a light emitting diode, and may further be an IR or NIR light emitting diode.

FIG. 2B is a front view of the camera assembly from FIG. 2A. As can be seen, the light source 40 is aligned along axis 64 and displaced from axis 44 of the concentrator 30 as described above.

FIG. 2C is a front view of another camera assembly in accordance with the present invention. In this embodiment, two light source assemblies 50 and 52 are used with concentrators 12 and light sources 40, and a single imaging sensor 34. The provision of multiple concentrators and light sources may be employed to provide necessary illumination coverage for a vehicle interior. As can be seen, the light sources 40 are aligned with the horizontal axis 64 of the concentrators 12 and displaced from their vertical central axes 44.

The disclosed design may be applicable to any camera system which uses NIR or IR wavelength illumination for sensing or machine vision purposes. This can be applicable in security camera situations or automotive vision features for which the design is used. The design can be combined with the aforementioned bandpass filtration in order to veil/remove the camera and NIR/IR LED illumination from view of the human eye entirely.

Blocking visible light (400-700 nm) and passing through the IR or NIR wavelengths to which the system is sensitive does not eliminate “red glow.” It can only reduce the intensity of a visible (400-700 nm) light which the LED may output only mitigating the intensity of the “red glow.” This does not solve the issue of “red glow” when the human eye views the LED on axis to the fovea. The disclosed design will remove the “red glow” by redirecting the LED light to no longer be on axis to the fovea.

Additionally, shifting the wavelength output of the NIR or IR LED to a longer wavelength, using 940 nm illumination as opposed to 850 nm, may only decrease the intensity of the “red glow” but may not eliminate it when viewed on axis to the fovea. By utilizing a reflective concentrator at an orientation which causes the NIR/IR LED to no longer be on axis to the fovea the LED becomes no longer visible.

If the intensity of the NIR/IR LED is decreased or the pulse duration can be increased to mitigate or eliminate “red glow” the functionality of the camera system is limited. If the LED is left “always on” the LED will be at risk of burning out or having decreased intensity of output. The impact of this will be to reduce the quantum efficiency of the camera system and decrease the overall sensitivity of the system. The disclosed design is capable of increasing the intensity of the LED and therefore increasing the camera system sensitivity while eliminating the “red glow.”

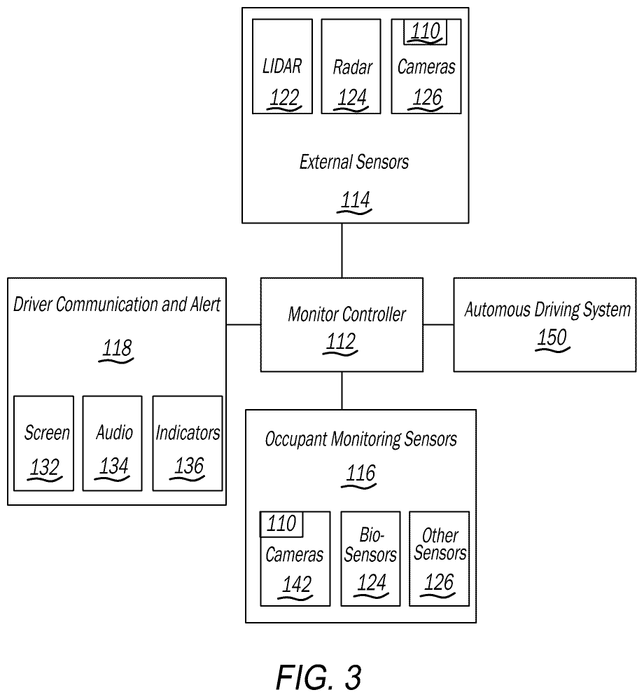

FIG. 3 is a schematic view of a monitoring system. The concentrators and/or camera assembly described above may be incorporated into such a monitoring system. For example, the concentrators may be identified as reference numerals 110. The monitor controller 112 may monitor object within the cabin (e.g. driver, occupant, etc.) or objects external to the vehicle (e.g. cars, pedestrians, etc.). In accomplishing these tasks, the monitor controller 112 may be in communication with external sensors 114. The external sensors may monitor the environment surrounding the vehicle as the vehicle is stopped or as the vehicle proceeds along its route. The external sensors may include Lidar 122, radar 124, and cameras 126. However, it is understood that other external sensing technologies may be used, for example, ultrasonic sensors or other distance or environmental measuring sensors within the vehicle. In some examples, the sensors may include temperature sensors, moisture sensors, as well as, various features that may be derived from sensors such as the camera. These features may include whether there is a snowy condition, the amount of glare from the sun, or other external environmental conditions. The monitor controller 112 may use input from the external sensors 114 to provide environmental context to the monitor controller 112. The monitor controller 112 may also be in communication with an occupant monitoring sensors system 116. The occupant monitoring system 116 may include cameras 142, biosensors 144, as well as other sensors 146. The cameras may be mounted in different positions, orientations, or directions within the vehicle to provide different viewpoints of occupants in the vehicle. The cameras may be used to analyze gestures by the occupants or determine the positon and/or orientation of the occupant, or monitor indications of the occupant such as facial features indicative of emotion or condition. The biosensors 144 may include touch sensors for example, to determine if the driver is touching a certain control such as the steering wheel or gear shift. The biosensors 144 could include a heart rate monitor to determine the heart rate of the passenger, as well as, other biological indications such as temperature or skin moisture. In addition, other sensors 146 may be used such as presence, absence or position sensors to determine for example, if the occupant is wearing a safety belt, a weight sensor to determine the weight of the occupant.

The monitor controller 112 may also be in communication with a driver communication and alert system 118. The driver communication and alert system 118 may include video screens 132, audio system 134, as well as other indicators 136. The screen may be a screen in the console and may be part of the instrument cluster, or a part of a vehicle infotainment system. The audio system 134 may be integrated into the vehicle infotainment system or a separate audio feature for example, as part of the navigation or telecommunication systems. The audio system 134 may provide noises such as beeps, chirps or chimes or may provide language prompts for example, asking questions or providing statements in an automated or pre-recorded voice. The driver communication and alert system 118 may also include other indicators for example, lamps or LEDs to provide a visual indication either on the instrument cluster or elsewhere in the vehicle including for example, on the side view mirrors or rear view mirror. The monitor controller 112 may also be in communication with an autonomous driving system 150. The autonomous driving system 150 may utilize input from the internal and external sensors when making driving decisions.

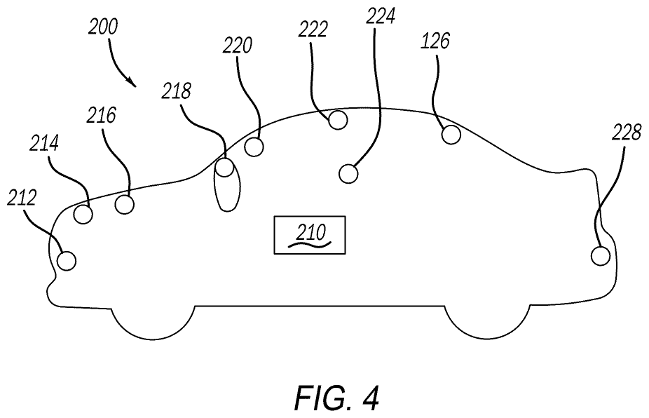

Now referring to FIG. 4, a schematic view of the vehicle 200 is provided. The vehicle may include a sensor processer 210. The sensor processer 210 may include one or more processors to monitor and/or measure the input from various vehicle sensors both inside and outside of the vehicle. For example, as described previously, the vehicle may include a range sensor 212, for example, an ultrasonic sensor to determine if an object is directly from another vehicle 200. The vehicle may include a radar sensor 214. The radar sensor 214 may be a forward looking radar sensor and provide distance and location information of objects that are located within the radar sensing field. As such, a vehicle may include a forward facing radar shown as radar 214. However, a rearward or sideward looking radar may also be included. The system may include a Lidar 216. The Lidar 216 may provide distance and location information for vehicles that are within the sensing field of the Lidar system. As such, the vehicle may include a forward looking Lidar system as shown with regard to Lidar 216. However, rearward or sideward looking Lidar systems may also be provided.

The vehicle 200 may also include biosensors 218. The biosensor 218 may for example, be integrated into a steering wheel of the vehicle. However, other implementations may include integration into seats and/or a seatbelt or within other vehicle controls such as the gear shift or other control knobs. Biosensor 218 may determine a heartbeat, temperature, and/or moisture of the skin of the driver of the vehicle. As such, the condition of the driver may be evaluated by measuring various biosensor readings as provided by the biosensor 218. The system may also have one or more inward or cabin facing cameras 220. The cabin facing cameras 220 may include cameras that operate in the white light spectrum, infrared spectrum, or other available wavelengths. The cameras may be used to determine various gestures of the driver, position or orientation of the driver, or facial expressions of the driver to provide information about the condition of the driver (e.g. emotional state, engagement, drowsiness and impairment of the driver). Further, bioanalysis may be applied to the images from the camera to determine the condition of the driver or if the driver has experienced some symptoms of some medical state. For example, if the driver's eyes are dilated, this may be indicative of a potential medical condition which could be taken into account in controlling the vehicle.

Cameras 222 may be used to view the external road conditions, such as in front of, behind, or to the side of the vehicle. This may be used to determine the path of the road in front of the vehicle, the lane indications on the road, the condition of the road with regard to road surface, or with regard to the environment external to the vehicle including whether the vehicle is in a rain or snow environment, as well as, lighting conditions external to the vehicle including whether there is glare or glint from the sun or other objects surrounding the vehicle as well as the lack of light due to poor road lighting infrastructure. As discussed previously, the vehicle may include rearward or sideward looking implementations of any of the previously mentioned sensors. As such, a side view mirror sensor 224 may be attached to the side view mirror of the vehicle and may include a radar, Lidar and/or camera sensor for determining external conditions relative to the vehicle including the position of objects such as other vehicles around the instant vehicle. Additionally, rearward facing camera 226 and ultrasonic sensor 228 in the rear bumper of the vehicle provide other exemplary implementations of rearward facing sensors that parallel the functionality of the forward facing sensors described previously.

The methods, devices, processing, and logic described above may be implemented in many different ways and in many different combinations of hardware and software. For example, all or parts of the implementations may be circuitry that includes an instruction processor, such as a Central Processing Unit (CPU), microcontroller, or a microprocessor; an Application Specific Integrated Circuit (ASIC), Programmable Logic Device (PLD), or Field Programmable Gate Array (FPGA); or circuitry that includes discrete logic or other circuit components, including analog circuit components, digital circuit components or both; or any combination thereof. The circuitry may include discrete interconnected hardware components and/or may be combined on a single integrated circuit die, distributed among multiple integrated circuit dies, or implemented in a Multiple Chip Module (MCM) of multiple integrated circuit dies in a common package, as examples.

The circuitry may further include or access instructions for execution by the circuitry. The instructions may be stored in a tangible storage medium that is other than a transitory signal, such as a flash memory, a Random Access Memory (RAM), a Read Only Memory (ROM), an Erasable Programmable Read Only Memory (EPROM); or on a magnetic or optical disc, such as a Compact Disc Read Only Memory (CDROM), Hard Disk Drive (HDD), or other magnetic or optical disk; or in or on another machine-readable medium. A product, such as a computer program product, may include a storage medium and instructions stored in or on the medium, and the instructions when executed by the circuitry in a device may cause the device to implement any of the processing described above or illustrated in the drawings.

The implementations may be distributed as circuitry among multiple system components, such as among multiple processors and memories, optionally including multiple distributed processing systems. Parameters, databases, and other data structures may be separately stored and managed, may be incorporated into a single memory or database, may be logically and physically organized in many different ways, and may be implemented in many different ways, including as data structures such as linked lists, hash tables, arrays, records, objects, or implicit storage mechanisms. Programs may be parts (e.g., subroutines) of a single program, separate programs, distributed across several memories and processors, or implemented in many different ways, such as in a library, such as a shared library (e.g., a Dynamic Link Library (DLL)). The DLL, for example, may store instructions that perform any of the processing described above or illustrated in the drawings, when executed by the circuitry.

As a person skilled in the art will readily appreciate, the above description is meant as an illustration of the principles of this application. This description is not intended to limit the scope or application of the claim in that the assembly is susceptible to modification, variation and change, without departing from spirit of this application, as defined in the following claims.

1. A camera assembly for a vehicle, comprising:
an imaging sensor configured to detect objects within a field of view; and
a light source assembly configured to illuminate the field of view, the light source assembly including a light source and a reflective concentrator defining a central axis, an input aperture and an output aperture, the output aperture centered with respect to the central axis, the input aperture displaced from the central axis along an illumination axis perpendicular to the central axis, wherein the light source is hidden from the field of view and configured to direct light from the light source to the field of view.

2. The camera assembly of claim 1, wherein a surface of the reflective concentrator is revolved around the central axis.

3. The camera assembly of claim 1, wherein the light source is an infra-red or a near infra-red light emitting diode.

4. The camera assembly of claim 1, wherein the reflective concentrator is a reflective compound parabolic concentrator.

5. The camera assembly of claim 1, wherein the reflective concentrator is formed by a parabola surface with a focus at one edge of the input aperture, the parabola surface being rotated about an axis that extends perpendicular to the entrance aperture.

6. The camera assembly of claim 1, wherein the reflective concentrator is formed by a parabola surface with a focus at one edge of an entrance aperture, the parabola surface being rotated about an axis that extends through a center of the entrance aperture.

7. The camera assembly of claim 1, wherein the light assembly includes a second light source that is hidden from the field of view and a second reflective concentrator configured to direct light from the second light source to the field of view.

8. The camera of claim 7, wherein the second reflective concentrator is formed by a parabola surface with a focus at one edge of an entrance aperture, the parabola surface being rotated about an axis that extends perpendicular to the entrance aperture.

9. The camera of claim 7, wherein the second reflective concentrator is formed by a parabola surface with a focus at one edge of an entrance aperture, the parabola surface being rotated about an axis that extends through a center of the entrance aperture.

10. The camera of claim 1, wherein the reflective concentrator is configured to direct light from the light source to an angle that is greater than 10 degrees from the central axis of the reflective concentrator.
